(19) United States
(12) Patent Application Publication
(10) Pub. No.: US 2025/0030101 A1
(43) Pub. Date: Jan. 23, 2025

(54) BATTERY TRAY

(71) Applicant: BENTELER AUTOMOBILTECHNIK GMBH, Paderborn (DE)

(72) Inventors: Christian HANDING, Langenberg (DE); Christoph NITSCHKE, Bad Lippspringe (DE); Stefan SCHMITZ, Bielefeld (DE); Kai MICHEL, Salzkotten (DE)

(21) Appl. No.: 18/773,981

(22) Filed: Jul. 16, 2024

(30) Foreign Application Priority Data
Jul. 17, 2023 (EP) 23185935.6

(51) Int. Cl. H01M 50/242; H01M 50/244; H01M 50/249

(52) U.S. Cl. CPC H01M 50/242; H01M 50/244; H01M 50/249

(57) ABSTRACT

The invention relates to a battery tray for holding battery elements for providing electrical energy in electrically driven vehicles. The battery tray has a battery pan having a reinforcing structure which is arranged on the outside in front of a side wall of the battery pan. The reinforcing structure comprises an outer profile which is configured as U-shaped in cross-section with a web and two legs as well as an opening. The outer profile is directed with the opening towards the battery pan and is connected to the battery pan using the legs. In the longitudinal direction (LR) of the outer profile, multiple sleeves are provided at a distance from one another, wherein a sleeve extends between the legs and connects openings in the legs.

The invention relates to a battery tray according to the features in the preamble of claim 1.

Battery trays, which are arranged between the axles of the vehicle, are used to hold battery elements for providing electrical energy in electrically powered vehicles. One of the essential safety requirements for a battery tray is good crash performance. In order to satisfy this requirement, the battery tray is protected by an external reinforcing structure. The main function of the reinforcing structure is to dissipate energy in case of a crash and to increase the overall rigidity of the battery tray and the body. This increases the crash safety of the batteries, in particular in the event of a side impact.

DE 10 2018 126 068 A1 makes a battery tray for an electric vehicle part of the prior art. The battery tray has a battery pan which is inserted into an outer frame and is closed by a lid. The frame is produced in cross section from at least two profile components joined together, wherein at least one of these profile components is produced as a sheet metal formed component.

In the battery tray known from US 2010/0307848 A1, the battery pan is also protected by a reinforcing structure that surrounds it on the outside and has a hollow chamber.

DE 10 2017 217 814 A1 discloses a battery housing for a vehicle having a battery tray having a lateral peripheral outer frame. A mounting profile is connected to the outer frame for fastening the battery housing to the vehicle. The mounting profile can be composed of multiple parts. In one embodiment, the mounting profile is configured as U-shaped in cross section with a web and two legs and an opening, wherein the opening of the outer profile is directed towards the battery pan and the legs are connected to the battery pan.

A battery housing having a peripheral external connection profile is also described in DE 10 2016 214 974 A1.

Furthermore, WO 2017/207502 A1 discloses a battery housing having an external connection profile.

DE 11 2018 002 641 T5 discloses a vehicle body substructure for the lower part of a vehicle body.

Further prior art is provided by DE 20 2022 103 457 U1, WO 2018/029168 A1, US 2023/182828 A1, and WO 2022/098006 A1.

The battery trays have to be mechanically stable and fastened to the body or chassis of a vehicle. The battery pan is to be integrated as extensively as possible into the body, which presents design and assembly challenges.

The outer reinforcing structure in front of a side wall of the battery pan is constructed from one or more components. These are welded to one another and to the battery pan. The high number of individual components and the multitude of welded joints can result in warping in the welded construction. The high number of individual components also results in an increase in tolerances or tolerance chains. These, as well as any welding warpage, have to be compensated for in order to ensure a connection capable of mass production of the battery pan in a motor vehicle.

Proceeding from the prior art, the invention is based on the object of creating a battery tray improved with respect to function and assembly.

This object is achieved according to the invention by a battery tray according to claim 1.

A battery tray for holding battery elements for providing electrical energy in electrically driven vehicles has a battery pan having a reinforcing structure which is arranged on the outside in front of at least one side wall of the battery pan. The reinforcing structure has an outer profile. The inner profile is configured as U-shaped in cross section and has a web and two legs as well as an opening. The outer profile is a one-piece or single-shell U-shaped shell body and preferably does not have any further outer shells, which are known in the prior art for energy dissipation in case of a crash. The opening of the outer profile is directed towards the battery pan. The outer profile is connected to the battery pan via the legs.

Multiple sleeves are provided in the reinforcing structure. These are fastening or mounting sleeves, which are in particular cylindrical or in the form of rectangular tubes. Usually, multiple sleeves arranged at a distance from one another are provided in the longitudinal direction of the reinforcing structure. A sleeve extends between the legs of the inner profile over the entire height of the inner profile. The sleeve connects openings in the legs. The sleeves are oriented coaxially to the openings. The sleeve and opening lie on a common longitudinal axis. The sleeves are used to feed through fasteners via which the battery tray is secured in the body or chassis of a vehicle. In particular, the battery tray is secured to side sills and, if necessary, floor cross members in the motor vehicle via the sleeves and suitable fasteners.

The reinforcing structure extends in the longitudinal direction of the side wall. The outer profile forms a hollow profile together with the side wall of the battery pan at least over the majority of the length of the reinforcing structure. This is characterized by advantageous static and dynamic load behavior. In particular, the rigidity of the reinforcing structure transverse to the battery pan is improved. In the event of a side impact, the legs of the inner profile can deform with energy dissipation, wherein the outside leg of the outer profile acts as a tension strut and holds the legs in position relative to one another to a limited extent.

An advantageous embodiment provides that the sleeves have an upper and/or a lower collar. The sleeves have a sleeve body. A circumferential collar in particular is provided at one end or at both ends of the sleeve body. The collar is oriented outward from the sleeve body. In particular, the collar is a materially-uniform component of the sleeve or sleeve body.

It is also possible that a collar is formed by a separate collar body.

The collars absorb the friction and pressure forces that arise when tightening assembly elements guided through the sleeves, for example screw connecting elements. This can protect the surface of the components in the area of a screw connection from damage and reduce the surface pressure. In particular, the collars ensure tolerance compensation. The flat collar surface is larger than the sleeve surface, so that the sleeves or their sleeve bodies can be aligned or positioned horizontally before welding with the outer profile. The alignment takes place according to the defined assembly hole distances.

The sleeves can rest with their collars inside on the inner side of a leg of the outer profile.

The collars can rest on the legs on the outside, i.e. on the outer side.

A combination is also possible in which a first collar rests on an inner side of a first leg and a second collar rests on an outer side of a second leg.

The sleeve is joined to the outer profile or the legs of the outer profile in the area of the collar.

The sleeves extend between the opening in the lower leg and the opening in the upper leg and are joined to the legs. The legs can be reinforced in the area of the opening. Such a reinforcement can be achieved, for example, by embossing the material in the legs or by increasing the wall thickness in the area of an opening.

A further embodiment is that one or each sleeve is guided with an upper sleeve section and/or a lower sleeve section through an opening in a leg. The sleeve or sleeve section can terminate flush with the outside of the leg or protrude in relation to the outside with the sleeve section.

The sleeves can be formed in multiple parts and can have a first sleeve element and a second sleeve element. The sleeve elements have coaxial through openings and are connected to one another at mutually facing end sides. The connection is in particular friction-locked and/or form-fitting.

Each leg particularly advantageously has a joining flange at the end. The joining flanges are a one-piece component of the legs made of the same material and are connected at the ends to the legs directed towards the battery pan.

An embodiment which is particularly advantageous in practice provides that a lower leg has a lower joining flange, wherein the lower joining flange engages at least in some areas under a pan bottom of the battery pan. The lower leg is materially bonded to the battery pan using the lower joining flange, in particular welded, preferably spot welded or spot welded and adhesively bonded.

An upper leg has an upper joining flange, wherein the upper joining flange is joined to the side wall or an upper pan edge of the battery pan.

A further embodiment provides that a joining flange is set at an angle to a leg. In particular, the upper joining flange is set on the upper leg at an angle, preferably perpendicular to the leg and directed outwards away from it.

Furthermore, a leg can have multiple leg sections, wherein at least two leg sections are aligned differently relative to one another.

Between the at least two leg sections there can be a bend, a curve, a step, a kink, or even an indentation via which the leg sections merge into one another. The profiling and alignment of the leg sections in relation to one another increases their rigidity and improves their load behavior.

At least one stiffening element which increases the rigidity can be provided in the rear web of the outer profile. Such a stiffening element can be embodied, for example, by a bead, a redirection, or an embossing.

The outer profile can have sections in some areas having different wall thicknesses and/or different material qualities. In particular, the outer profile can be partially reinforced by reinforcing elements, in particular sheet metal components, so-called patches. These are sheet metal sections or patches in a geometrically adapted shape and material quality, which are preferably already joined in a flat state before the outer profile is manufactured and then formed together to form the outer profile. The patches are arranged on the inside or outside of the outer profile. The outer profile can also be produced from a Tailor Rolled Blank (TRB). As a result, the outer profile has different sheet thicknesses. The advantage here is the homogeneous transition between two thickness ranges.

The outer profile and the reinforcing elements or components can also consist of materials of different material quality.

The side wall of the battery pan can also be reinforced or have a reinforcement, at least in some areas. The side wall can be embodied thicker than the rest of the battery pan. It is particularly advantageous that the side wall is provided with a reinforcement in the form of patches with adapted geometry and material quality.

A joining flange can have multiple joining tabs arranged at a distance from one another in the longitudinal direction of the outer profile. Cutouts or recesses are provided between the joining tabs.

The outer profile of the reinforcing structure is welded to the battery pan using the joining flanges and/or the joining tabs. The lower leg is welded to the battery pan in the area of the bottom lateral edge of the battery pan and the upper leg of the outer profile is welded to the upper area of the side wall or an upper flange of the battery pan.

In practice, material-bonding joining by means of spot welding and spot welding adhesive bonding is considered particularly advantageous. Spot welding adhesive bonding represents a combination of adhesive bonding with the spot welding joining method. Spot welded joints as well as spot welded adhesive joints have not only high strengths and a high stiffening effect, but also a sufficiently high elongation at fracture, even under sudden loads such as a crash.

A further embodiment that is advantageous in practice provides that installation elements are provided in the reinforcing structure. Installation elements can be load guide bodies, bulkhead plates, and similar internal reinforcing and/or functional components. In addition to the pure reinforcing or stiffening of defined length sections of the reinforcing structure and the increased energy dissipation, they are primarily used to create load paths for targeted passing on into the remainder of the battery tray structure, in particular via the above-mentioned internal struts in the interior of the battery tray.

In addition to installation elements in the reinforcing structure, reinforcing or stiffening elements can also be integrated in the battery pan. Such reinforcing or stiffening elements can be formed by longitudinal and/or transverse profiles or struts that extend on the pan bottom.

Furthermore, a lid can form the upper end of the battery pan, the battery tray is particularly advantageously designed and intended to be integrated into the body or chassis of a vehicle. The battery tray forms a supporting part of the body (cell-to-body). The floor of the vehicle can form the battery lid in this case.

The battery pan is in particular a deep-drawn part made in one piece and of one material. The outer profile is also preferably produced using compression molding or deep-drawing technology. Due to its U-shaped cross section, the inner profile has a channel-like course in which multiple sleeves are arranged at a distance from one another in the longitudinal direction.

The battery pan can also be formed from a sheet metal plate by folding it to form the battery pan. For this purpose, a sheet metal plate is provided, the geometry of which corresponds to the development of the battery pan. A cooling plate can optionally be joined directly to the sheet metal plate before it is then folded to form the battery pan. The battery pan is designed as a folded component. Folded corners of the battery pan are joined and sealed.

The battery pan, as well as the reinforcing structure and the components forming the reinforcing structure, in particular the outer shell, can be formed by hot stamping steel sheets. Hot stamping is also known as press hardening. During hot stamping, a sheet of manganese-boron steel is heated to a temperature above the specific austenitization temperature of the material, placed in a forming tool, and hot formed into the formed component, wherein it cools during forming. Clamped in the forming tool, the formed components are hardened by cooling.

Coated steel sheets that can be hot stamped can also be used here. In particular these are manganese-boron steel sheets provided with an aluminum/silicon coating. The components of the reinforcing structure and the battery pan have a tensile strength of 1,000 MPa and higher.

The battery pan as well as the outer profile of the reinforcing structure can also be manufactured from extra-high-strength and ultra-high-strength cold-form steels. These components have a tensile strength of greater than 980 MPa. In particular, the outer profile has a tensile strength of greater than or equal to 1,180 MPa.

In principle, in both cases it is also possible to use tailored blanks of different sheet thicknesses, steel grades, or technologies to create custom-tailored strength properties having local soft zones for the battery pan as well as for the outer profile, for example, to deliberately increase the transverse rigidity and increase the crash performance and, for example, to prevent cracks during welding or to set locally weakened zones having better deformation capacity for energy absorption.

The invention is described in more detail hereinafter with reference to exemplary embodiments illustrated in the drawings. In the figures:

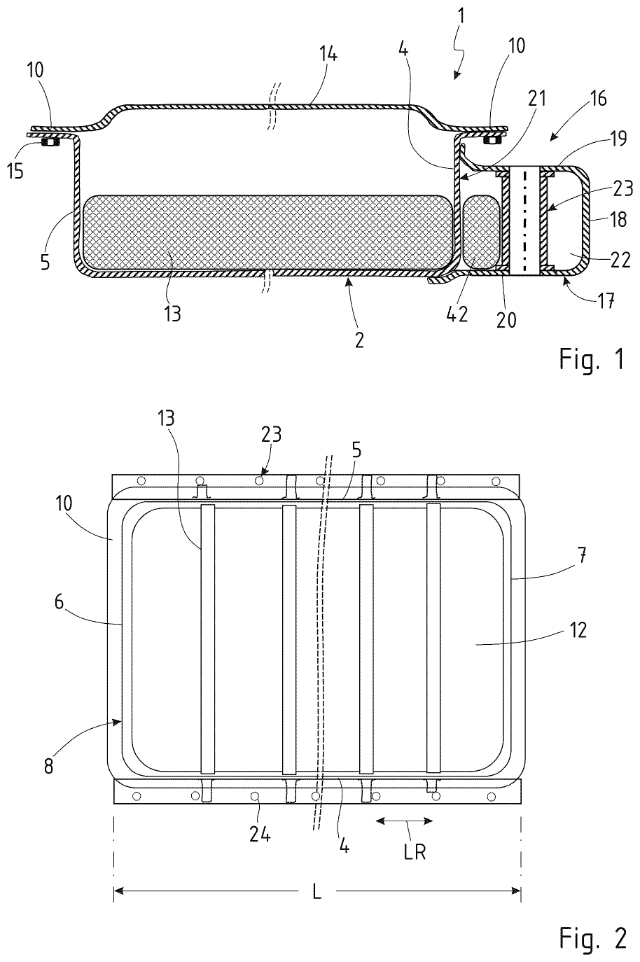

FIG. 1 shows a battery tray according to the invention in a cross-sectional view;

FIG. 2 shows the battery tray in a schematic top view,

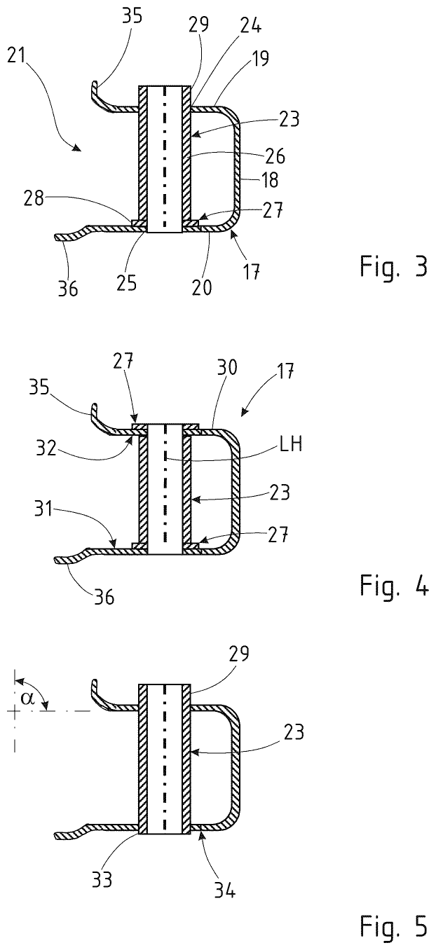

FIG. 3 shows a view of a section of the battery tray showing a further embodiment of a reinforcing structure;

FIG. 4 like 3, shows a view of a section of the battery tray showing a second embodiment of a reinforcing structure; second embodiment;

FIG. 5 like 3, shows a view of a section of the battery tray showing a third embodiment of a reinforcing structure;

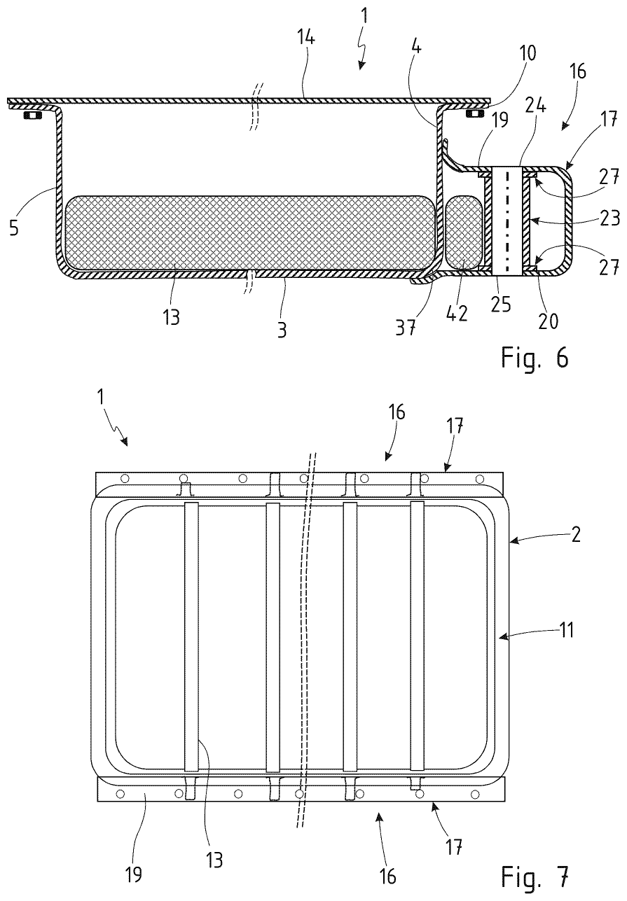

FIG. 6 shows a further embodiment of a battery tray according to the invention in a cross-sectional view;

FIG. 7 shows the battery tray as shown in FIG. 6 in a schematic top view;

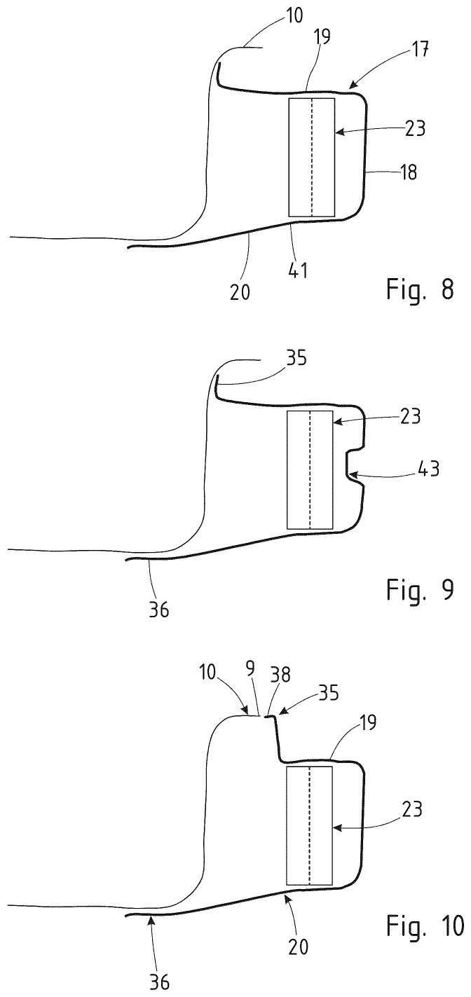

FIG. 8 shows a view of a section of the battery tray showing a further embodiment of a reinforcing structure;

FIG. 9 like 8; shows a view of a section of the battery tray showing a further embodiment of a reinforcing structure;

FIG. 10 like 8; shows a view of a section of the battery tray showing a further embodiment of a reinforcing structure;

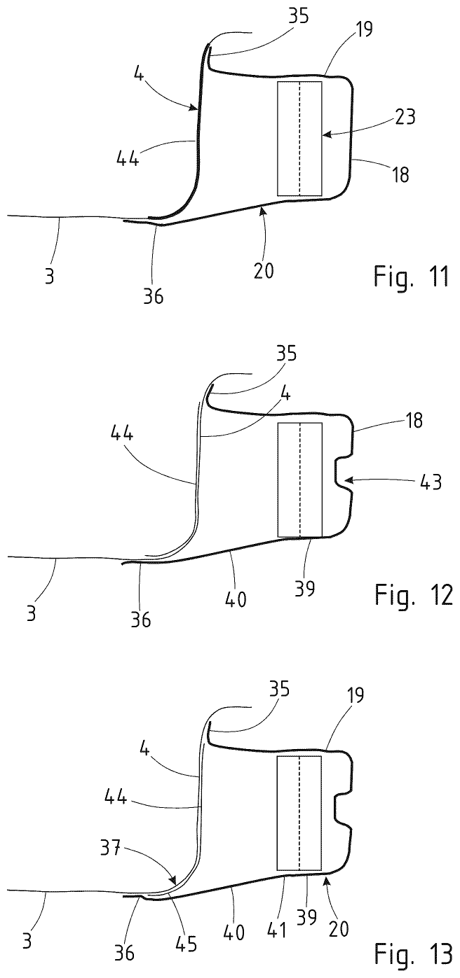

FIG. 11 like 8; shows a view of a section of the battery tray showing a further embodiment of a reinforcing structure;

FIG. 12 like 8; shows a view of a section of the battery tray showing a further embodiment of a reinforcing structure;

FIG. 13 like 8; shows a view of a section of the battery tray showing a further embodiment of a reinforcing structure;

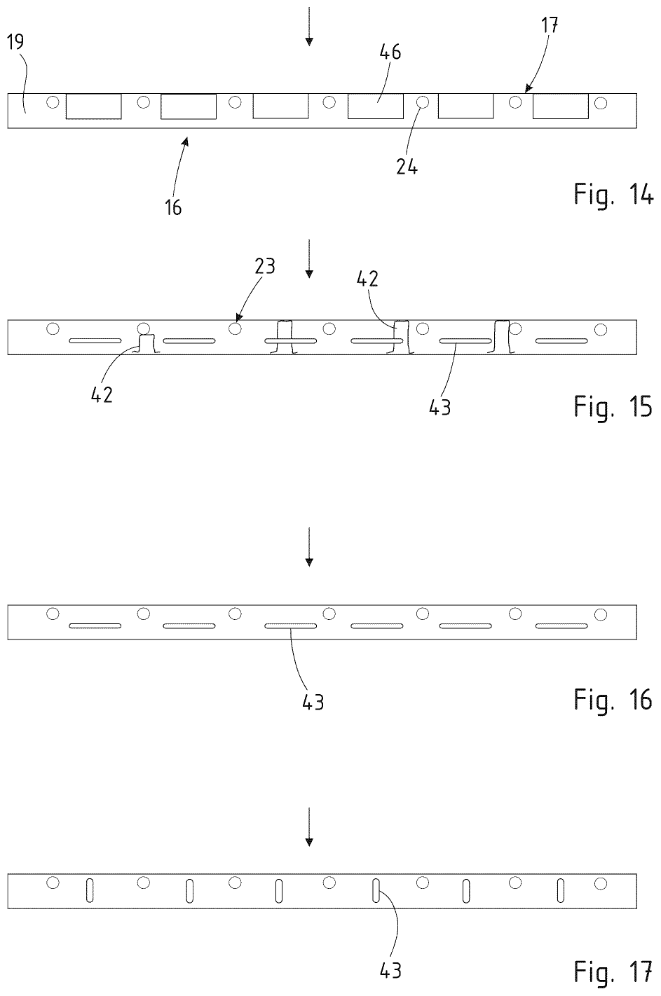

FIG. 14 shows a technically schematic and simplified top view of a reinforcing structure from above;

FIG. 15 shows a top view of another embodiment of an reinforcing structure;

FIG. 16 shows a top view of another embodiment of an reinforcing structure;

FIG. 17 shows a top view of another embodiment of an reinforcing structure;

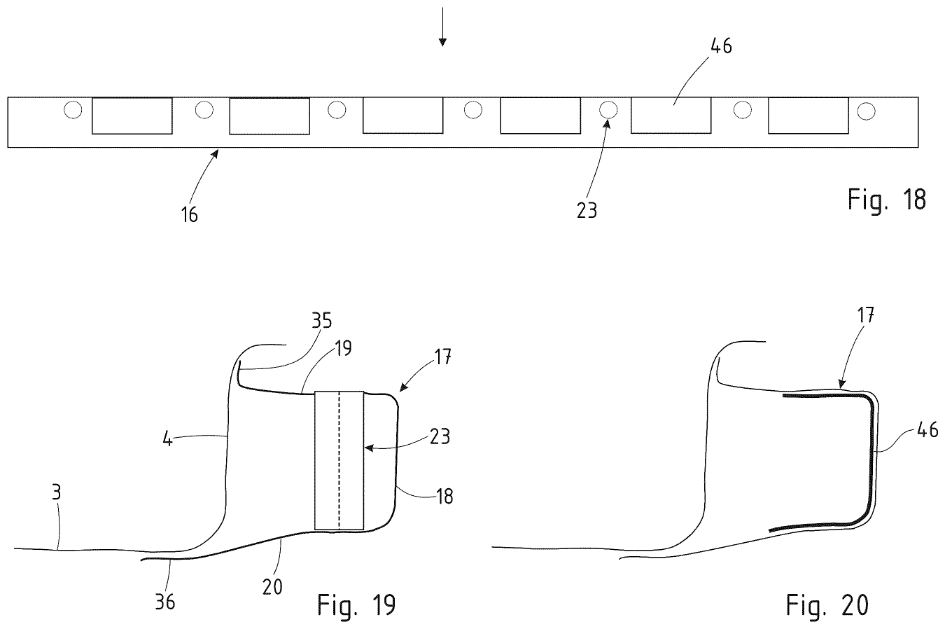

FIG. 18 shows a top view of another embodiment of an reinforcing structure;

FIG. 19 shows a cross section through the reinforcing structure according to the representation of FIG. 18 in the area of a sleeve;

FIG. 20 shows a cross section through the reinforcing structure according to the illustration in FIG. 18 in the area of a reinforcing element;

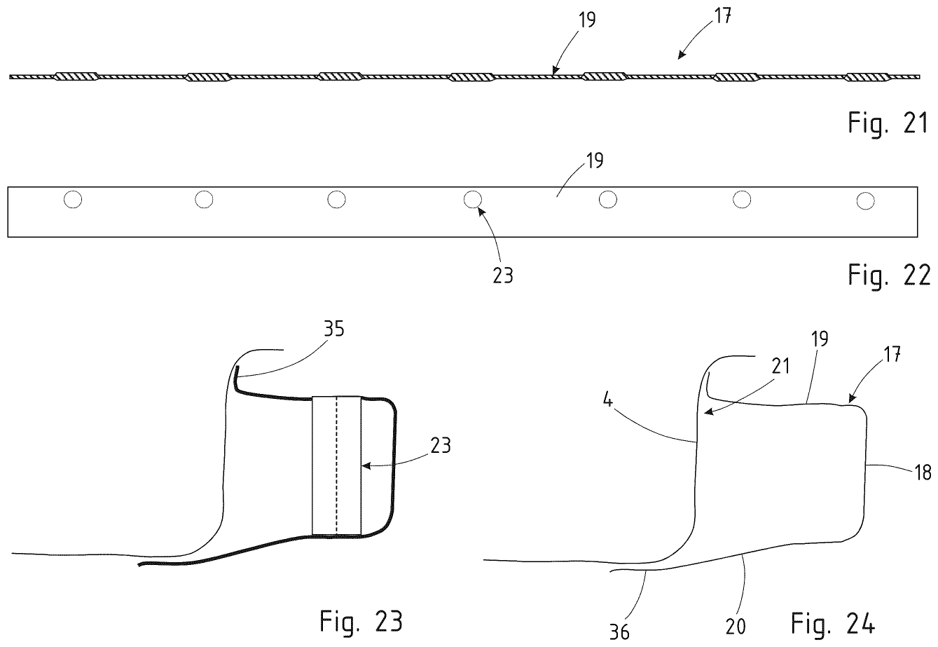

FIG. 21 shows a longitudinal section through the upper leg of an outer profile of a reinforcing structure;

FIG. 22 shows a technically schematic and simplified top view of the upper leg of a reinforcing structure;

FIG. 23 shows a cross section through the stiffening structure corresponding to the representations of FIGS. 21 and 22 in the area of a sleeve;

FIG. 24 shows a cross section through the reinforcing structure in the area outside a sleeve;

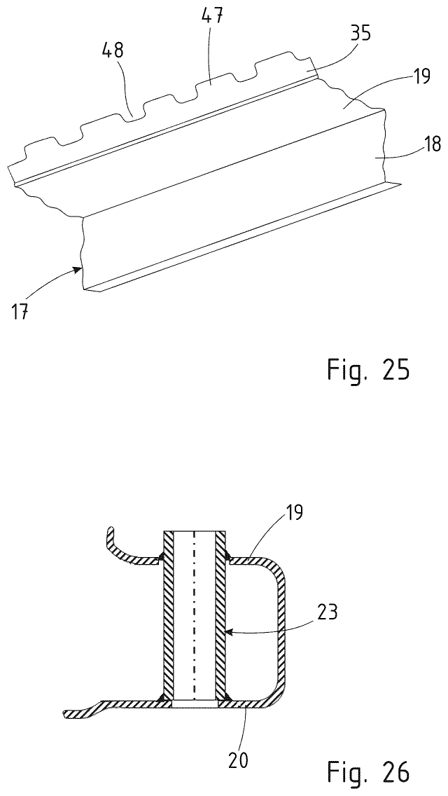

FIG. 25 shows a section of the outer profile of a reinforcing structure; and

FIG. 26 shows a view of a section of the battery pan showing a further embodiment of a reinforcing structure;

In FIGS. 1 to 26, the same reference numerals are used for identical or functionally corresponding components or component parts, even if a repeated description is omitted for reasons of simplicity.

FIGS. 1 and 2 as well as FIGS. 6 and 7 show a battery tray 1 according to the invention and components thereof.

The battery tray 1 has a battery pan 2 deep-drawn from sheet steel. The battery pan 2 is configured as rectangular in cross section and has a pan bottom 3 and side walls, namely two longitudinal walls 4, 5 and two end walls 6, 7, which complement one another to form a circumferential pan wall 8. On the upper pan edge 9, outwardly directed flange sections 10 extend along the longitudinal walls 4, 5 and the end walls 6, 7, which also complement one another in a circumferentially closed manner to form an upper flange 11. The pan wall 8 delimits a pan interior 12 of the battery pan 2.

A plurality of inner struts 13 are optionally arranged in the pan interior 12. The inner struts 13 extend on the pan bottom 3 transversely between the longitudinal walls 4, 5 and are secured by material bonding in the battery pan 2.

The battery pan 2 is closed on the top side, with a seal interposed, by a lid 14, which rests on the flange 11 at the edge. In the exemplary embodiments shown, the lid 14 is detachably connected to the battery pan 2 by means of screw connection means 15.

The battery tray 1 has a reinforcing structure 16. The reinforcing structure 16 extends on the outside of the battery pan 2 in front of the longitudinal walls 4, 5.

The cross-sectional views in FIGS. 1 and 2 each show a reinforcing structure 16 only on one side of the battery pan 2. The views in FIGS. 2 and 7 illustrate that a reinforcing structure 16 is arranged on both longitudinal sides of the battery pan 2 along the longitudinal walls 4, 5.

The end walls 6, 7 can also optionally be connected to a corresponding reinforcing structure 16.

In a further embodiment (not shown), the battery tray 1 can be rotated by 90° around the vertical axis with respect to the installation position in the motor vehicle in comparison to the embodiment according to FIGS. 1 and 2, so that the battery tray 1 could be coupled to bottom cross members or ladder frame cross members via the reinforcing structure 16.

The reinforcing structure 16 has an outer profile 17. The outer profile 17 is configured as U-shaped in cross section and has a web 18 as well as two legs 19, 20 and an opening 21. The opening 21 extends over the length L of the outer profile 17, which corresponds to the length of the reinforcing structure 16. The opening 21 of the outer profile 17 is directed towards the battery pan 2. The legs 19, 20 are connected to the battery pan 2. The opening 21 of the outer profile 17 directed towards the battery pan 2 is closed by a longitudinal wall 4 or 5 of the battery pan 2. The rear web 18 is located on the outside on the side facing away from the longitudinal wall 4, 5 of the battery pan 2.

The outer profile 17 is a sheet metal formed part which is formed in one piece from a steel sheet. The outer profile 17 can be a hot-stamped sheet steel component or a cold-formed formed component made of, in particular, ultra-high-strength (UHSS) cold-form steels. A UHSS formed component has a tensile strength Rm>980 MPa and a proportional martensitic structure.

The legs 19, 20 and the web 18 enclose a longitudinal channel. The outer profile 17 forms, together with a respective longitudinal wall 4, 5 of the battery pan 2, a hollow profile 22 at least over the predominant part of the length L of the reinforcing structure 16. The reinforcing structure 16 extends in the longitudinal direction LR in front of a side wall 4, 5.

Multiple sleeves 17 are provided in the hollow profile 23 of the reinforcing structure 16. These extend vertically between the legs 19, 20 of the outer profile 17. Openings 24, 25 are provided in the upper leg 19 and the lower leg 20, which are connected by the sleeves 23 (see also FIGS. 3 to 5 in this regard).

The sleeves 23 are arranged at a distance from one another in the longitudinal direction LR of the outer profile 17 and the reinforcing structure 16.

Each sleeve 23 has a sleeve body 26. In the sleeve 23 in the embodiment according to FIG. 3, a circumferential collar 27 is provided at the lower end of the sleeve body 26. This can be formed by a separate disk body 28. The collar 27 can also be an integral part of the sleeve 23 made of the same material. With a sleeve section 29 at the upper end of the sleeve body 26, the sleeve 23 is guided through the opening 24 in the upper leg 19 and protrudes in relation to the outer side 30 of the upper leg 19.

In the sleeve 23 in the embodiment according to FIG. 4, a collar 27 is provided at the lower end of the sleeve body 26. This collar concentrically encloses the lower opening 25 in the lower leg 20 and rests against the inner side 31 of the lower leg 20. The sleeve body 26 of the sleeve 23 rests on the upper leg 19 circumferentially around the opening 24 on the inner side 32 of the upper leg 19. On the outside, concentric with the opening 29 or the sleeve longitudinal axis LH, an upper collar 27 is provided which rests on the outer side 30 of the upper leg 19.

In the sleeve 23 according to the illustration in FIG. 5, the sleeve 23 or its sleeve body 26 has an upper sleeve section 29 and a lower sleeve section 33. With the upper sleeve section 29, the sleeve 23 is guided through the opening 24 in the upper leg 19. With the lower sleeve section 33, the sleeve 23 is guided through the opening 25 in the lower leg 20.

The lower sleeve section 33 ends approximately flush with the outer side 34 of the lower leg 20. The upper sleeve section 29 protrudes in relation to the outer side 30 of the upper leg 19.

In the case of the sleeves 23 in the embodiment according to the illustrations in FIGS. 1 and 6, a collar 27 is provided in each case at the upper end and at the lower end of the sleeve body 26, with which the sleeve 23 rests on the inside on the upper leg 19 or on the lower leg 20.

The openings 24 in the upper leg 19 and the openings 25 in the lower leg 20, the sleeves 23, and the collars 27 each lie on a common sleeve longitudinal axis LH and are arranged concentrically thereto.

Tolerance compensation can be achieved in the collarless sleeve 23 according to FIG. 5 when directly coupled to the legs 19, 20 via a suitable welding process using a relatively large amount of welding filler material. This is shown as an example in FIG. 26.

At the ends of the legs 19, 20, joining flanges 35, 36 are provided.

The lower leg 20 has a lower joining flange 36. The lower joining flange 36 engages at least in some areas under the pan bottom 3 of the battery pan 2 and is joined to the battery pan 2.

The upper joining flange 35 on the upper leg 19 is set at an angle α to the upper leg 19. In the embodiment according to FIGS. 1 and 3 to 6, the joining flange 35 is directed outward transversely to the upper leg 19 and in particular is directed at a right angle away from the upper leg 19. The transition from the leg 19 to the joining flange 35 is rounded.

The outer profile 17 is joined by material bonding to the battery pan 2. This is done via the lower joining flange 36 and the upper joining flange 35. The lower joining flange 36 engages in some areas under the lower longitudinal edge section 37 of the battery pan 2. The upper joining flange 35 is supported against the side wall 4, 5 of the battery pan 2.

In the illustration in FIG. 10, a joining web 38 directed towards the upper pan edge 9 of the battery pan 2 is bent over on the upper joining flange 35. The joining web 38 abuts against the outer edge of the upper flange 11 and is joined thereto, in particular by laser welding.

With the exception of the butt joint, the materially-bonded joining of the outer profile 17 and the battery pan 2 is carried out in particular by spot welding or spot welding adhesive bonding.

The sleeves 23 shown in FIGS. 8 to 19 and 22 and 23 are shown in a technically simplified manner and are to be understood schematically. The sleeves 23 each extend between an opening 25 in the lower leg 20 and an opening 24 in the upper leg 19 of the outer profile 17 and connect them. The sleeves 23 are configured and intended so that screw fasteners can be passed through them and the battery tray 1 can be fixed in the body or chassis of a vehicle. The sleeve 23 also basically has a supporting function of the outer profile 17 itself against deformation caused by the screwing force. The battery tray 1 is attached in a vehicle via the outer profile 17 and the sleeves 23 arranged therein by means of suitable screw fasteners.

In particular, the lower leg 20 can have at least two leg sections 39, 40 which are aligned differently relative to one another. In this regard, reference is made to the embodiments of the outer profile 17 according to the illustrations 8 to 10. The lower leg 20 has a first leg section 39. The first leg section 39 extends essentially parallel to the upper leg 19. The opening 25 and the sleeve 23 communicating with the opening 25 are located in the first leg section 39 of the lower leg 20. The second leg section 40 adjoins the first leg section 39 via a bend 41 and extends at an acute angle directed away from the first leg section 39 in the direction of the lower joining flange 36. In particular, the first leg section 39 is shaped or stamped to locally match an end face of the sleeve 23, while the second leg section 40 is aligned offset and/or inclined from a projection plane of the end face of the sleeve 23.

In FIG. 1 and FIGS. 6 and 7, an installation element 42 is shown in schematic and simplified form, which is installed in the outer profile 17 of the reinforcing structure 16. Such installation elements 42 can be, for example, load guide bodies or bulkhead plates. These are joined to the inner profile 17, in particular joined by material bonding. Installation elements 42, which are configured in a hat shape and have different heights, can also be seen in FIG. 15 in a top view.

FIGS. 8 to 13 each show the outer profile 17 of a reinforcing structure 16 and a section of the battery pan 2. The sleeve 23 is designed without a collar and ends flush with the lower leg 20 and the upper leg 19 and extends between the openings 24, 25. The sleeve 23 can be replaced by sleeve shapes according to FIGS. 1 and 3 to 5. The figures are presented in a technically simplified manner and are to be understood schematically.

The outer profile 16 is a hot-formed and press-hardened or cold-formed high-strength shell component. The battery pan 2 is a hot-formed and press-hardened sheet steel component or a cold-formed component made of ultra-high-strength cold-formed steel.

The longitudinal walls 4, 5 of the battery pan 2 can be reinforced in some areas and in particular can be made from a tailor welded blank, a tailor rolled blank, or can be reinforced by sheet metal components or patches. The outer profile 17 is joined to the battery pan 2.

In the embodiments according to the illustrations in FIGS. 9, 12, and 13, a stiffening element 43 in the form of a bead is provided in the outside web 18 of the outer profile 17.

Stiffening elements 43 in the form of beads in different designs are also shown in FIGS. 15, 16, and 17.

A battery pan 2 partially reinforced in the area of the side wall 4 by a reinforcement 49 is shown in the representation in FIG. 11. The side wall 4 is designed to be thicker at least in some areas than the pan bottom 3 and the upper pan edge 9. The battery pan 2 is manufactured from a tailor rolled blank for this purpose.

In the embodiment according to the illustration in FIG. 12, the side wall 4 of the battery pan 2 is reinforced on the inside by a reinforcement in the form of a patch.

In the embodiment according to the illustration in FIG. 13, the side wall 4 of the battery pan 2 is reinforced on the outside on the side facing toward the opening 21 of the outer profile 17 by a reinforcement 49 in the form of a patch. The reinforcement 49 extends around the lower longitudinal edge section 37 of the battery pan 2. The lower joining flange 36 extends over the lower section 45 of the reinforcement 44 and is joined to the pan bottom 3.

Reinforcing elements 46 in the outer profile 17 are arranged at intervals in the longitudinal direction within the reinforcing structure 16 in the outer profile 17 according to the embodiment of FIG. 14. In particular, reinforcing components are placed between the sleeves 23. The reinforcing elements 46 are preferably sheet metal sections or patches which can be joined to the outer profile 17 on the inside or outside.

FIG. 18 also shows such a design.

In FIGS. 14 to 18, the arrow shows the direction of impact in the event of a side impact.

FIG. 19 shows a section through the outer profile 17 of the reinforcing structure 16 in the area of a sleeve 23.

FIG. 20 shows a section through the outer profile 17 in the area of a reinforcing element 46. These are patches configured in a U shape that are adapted to the inner contour of the outer profile 16 and that cover the upper leg 19 and the lower leg 20 in some areas and completely cover the rear web 18 of the outer profile 17.

The outer profile 17 of a reinforcing structure 16, which is made from a tailored welded blank, is explained on the basis of FIGS. 21 to 24. FIG. 21 shows a section through the upper leg 19. The different wall thicknesses can be seen. In the area of a sleeve 23, the wall thickness is greater in each case than in the interposed leg sections 39, 40. FIG. 23 shows a section through the outer profile 17 in the area of a sleeve 23. FIG. 24 shows a section through the outer profile 17 in the area outside a sleeve 23.

From the illustration in FIG. 25, it can be seen that a joining flange 35, 36, in the illustrated exemplary embodiment the upper joining flange 35, has multiple joining tabs arranged at a distance from one another in the longitudinal direction of the outer profile 17. Recesses 48 are provided in the joining flange 35 between the joining tabs 47.

### REFERENCE SIGNS

1—battery tray
2—battery tray
3—pan bottom
4—longitudinal wall
5—longitudinal wall
6—end wall
7—end wall
8—pan wall
9—pan edge
10—flange section
11—upper flange
12—pan interior
13—inner strut
14—lid
15—screw connecting means
16—reinforcing structure
17—outer profile
18—web
19—leg
20—leg
21—opening
22—hollow profile
23—sleeve
24—opening
25—opening
26—sleeve body
27—collar
28—disk body
29—sleeve section
30—outside of 19
31—inside of 20
32—inside of 19
33—sleeve section
34—outside of 20
35—upper joining flange
36—lower joining flange
37—longitudinal edge section
38—joining web
39—leg section
40—leg section
41—bend
42—installation element
43—stiffening element
44—reinforcement
45—section of 44
46—reinforcing element
47—joining tab
48—recess
L—length
LH—sleeve longitudinal axis
LR—longitudinal direction
α—angle

1-15. (canceled)

16. A battery tray having a battery pan and a reinforcing structure which is arranged on the outside in front of a side wall of the battery pan, wherein the reinforcing structure has an outer profile which is configured as U-shaped in cross section with a web and two legs and an opening, wherein the opening of the outer profile is directed towards the battery pan and the legs are connected to the battery pan, wherein multiple sleeves are provided, wherein a sleeve extends between the legs and connects openings in the legs, wherein the reinforcing structure extends in the longitudinal direction (LR) of the side wall and the outer profile forms a hollow profile with the side wall at least over the predominant part of the length (L) of the reinforcing structure and/or in that the reinforcing structure extends in the longitudinal direction (LR) of the side wall and the outer profile forms a hollow profile with the side wall at least over the predominant part of the length (L) of the one side wall.

17. The battery tray according to claim 16, wherein one or each sleeve has an upper and/or a lower collar.

18. The battery tray according to claim 16, wherein one or each sleeve is guided with an upper sleeve section and/or with a lower sleeve section through an opening in a leg and ends flush with an outer side of the leg or protrudes in relation to the outer side.

19. The battery tray according to claim 16, wherein each leg has a joining flange at the end.

20. The battery tray according to claim 19, wherein a lower leg has a lower joining flange, wherein the lower joining flange engages at least in some areas under a pan bottom of the battery pan.

21. The battery tray according to claim 19, wherein a joining tab is set at an angle (α) to a leg.

22. The battery tray according to claim 19, wherein an upper leg has an upper joining flange, wherein the upper joining flange is joined to the side wall or an upper pan edge of the battery pan.

23. The battery tray according to claim 16, wherein at least one leg has multiple leg sections, wherein at least two leg sections are oriented differently relative to one another, in particular the first leg section is shaped or embossed adapted locally to an end face of the sleeve.

24. The battery tray according to claim 16, wherein installation elements are provided in the reinforcing structure, wherein the installation elements are designed in particular as load guiding elements and are part of the sleeves.

25. The battery tray according to claim 16, wherein the outer profile has at least one reinforcing element designed as a patch or patchwork.

26. The battery tray according to claim 16, wherein at least one stiffening element, in particular a bead, is provided in the web.

27. The battery tray according to claim 16, wherein the outer profile has sections having different wall thicknesses and/or different material qualities in some areas.

28. The battery tray according to claim 16, wherein the side wall of the battery pan is reinforced at least in some areas or has a reinforcement, in particular such that at least 30%, preferably at least 40% of the surface of the side wall is made double-layered.

29. The battery tray according to claim 16, wherein a joining flange has multiple joining tabs arranged at a distance from one another in the longitudinal direction of the outer profile, wherein the joining flanges are in particular spot welded or spot welded and adhesively bonded to the battery pan.

30. The battery tray according to claim 16, wherein the sleeve is designed in multiple parts and has a first sleeve element and a second sleeve element, wherein the sleeve elements have coaxial through openings and are connected to one another at end sides facing toward one another.
